(19) United States
(12) Patent Application Publication
(10) Pub. No.: US 2024/0278199 A1
(43) Pub. Date: Aug. 22, 2024

(54) IMPELLER ASSEMBLY AND BATTERY SLURRY MIXING AND STIRRING EQUIPMENT HAVING SAME

(71) Applicant: CONTEMPORARY AMPEREX TECHNOLOGY CO., LIMITED, Ningde (CN)

(72) Inventors: Liangliang WU, Ningde (CN); Liang JIANG, Ningde (CN); Yalong QING, Ningde (CN)

(73) Assignee: CONTEMPORARY AMPEREX TECHNOLOGY CO., LIMITED, Ningde (CN)

(21) Appl. No.: 18/648,511

(22) Filed: Apr. 29, 2024

Related U.S. Application Data
(63) Continuation of application No. PCT/CN2022/102949, filed on Jun. 30, 2022.

(51) Int. Cl. B01F 27/1132; B01F 23/53; B01F 27/053

(52) U.S. Cl. CPC B01F 27/1132; B01F 23/53; B01F 27/053

(57) ABSTRACT

The present application provides an impeller assembly and battery slurry mixing and stirring equipment having same. The impeller assembly provided in the present application includes: a stirring impeller, wherein the stirring impeller includes a rotating shaft and blades arranged around the rotating shaft along the circumferential direction; a surrounding plate, wherein the surrounding plate is arranged around the outer periphery of the stirring impeller, and the surrounding plate is provided with a plurality of discharge holes, the surrounding plate further includes a plurality of dispersing teeth, the plurality of dispersing teeth are arranged facing a rotation direction of the blades, and the plurality of dispersing teeth are distributed around the periphery of the plurality of discharge holes.

### CROSS-REFERENCE TO RELATED APPLICATION

The present application is a continuation of international application PCT/CN2022/102949, filed Jun. 30, 2022, which is incorporated herein by reference in its entirety.

### TECHNICAL FIELD

The embodiments of the present application relate to the technical field of mixing and stirring containers, and in particular to an impeller assembly and battery slurry mixing and stirring equipment having same.

### BACKGROUND ART

At present, traditional mixing and stirring equipment such as battery slurry mixers have problems of high energy consumption and low production capacity during use. The immature structure of traditional battery slurry mixers greatly reduces their mixing and dispersion effect on lithium-ion battery slurry. The mixing and dispersing process of lithium-ion battery slurry restricts the production capacity of lithium-ion battery slurry.

### SUMMARY OF THE INVENTION

In view of the above problems, embodiments of the present application provide an impeller assembly and mixing and stirring equipment for battery slurry having same. The impeller assembly can fully mix and disperse the battery slurry through a plurality of dispersing teeth, reducing the phenomenon that some battery slurry is not fully mixed and dispersed after passing through the impeller assembly.

The first aspect of the present application provides an impeller assembly, the impeller assembly includes: a stirring impeller, the stirring impeller includes a rotating shaft and blades arranged around the rotating shaft along the circumferential direction; a surrounding plate, the surrounding plate is arranged around the outer periphery of the stirring impeller, and the surrounding plate is provided with a plurality of discharge holes, the surrounding plate further includes a plurality of dispersing teeth, the plurality of dispersing teeth are arranged facing a rotation direction of the blades, and the plurality of dispersing teeth are distributed around the periphery of the plurality of discharge holes.

Arranging a plurality of dispersing teeth on the impeller assembly provided in the embodiment of the present application not only ensures the stirring of materials such as battery slurry, but also effectively disperses the battery slurry after stirring. Specifically, when the battery slurry is dispersed under the relative movement between the blades and the surrounding plate, while maintaining a high shear strength, the plurality of dispersing teeth on the surrounding plate can serve to cut particle groups through head-on collision with the particle groups, causing strong impact and disturbance to the particle agglomerates in the suspension, so that the battery slurry is fully mixed in the plurality of discharge holes of the surrounding plate, which is conducive to improving the dispersion effect on nano-scale material and high-solid content formulation. Therefore, the impeller assembly provided in this embodiment is able to fully mix and disperse the battery slurry through the plurality of dispersing teeth, reducing the phenomenon that part of battery slurry is not fully mixed and dispersed after passing through the impeller assembly.

In some embodiments, the surrounding plate includes a grid plate disposed around the periphery of the stirring impeller, the dispersing teeth include grid bars arranged on the grid plate, and side faces of the grid bars along the circumferential direction are arranged to face the rotation direction. In the grid plate provided in the embodiment of the present application, the dispersing teeth are arranged in an embedded structure. Compared with arranging the dispersing teeth protruding from the annular wall of the grid plate, the embedded dispersing teeth act on the battery slurry inside the surrounding plate, therefore, they can minimize the influence on the circulation efficiency and discharge efficiency of the battery slurry while dispersing and shearing the battery slurry.

In some embodiments, the blades are arranged as deflected blades that are reversely deflected with respect to the rotation direction of the stirring impeller, and the deflection direction of the dispersing teeth is arranged to be perpendicular or parallel to the deflected blades. By arranging the deflecting direction of the dispersing teeth to be perpendicular or parallel to the deflected blades, relatively balanced distribution of force between the deflected blades and the dispersing teeth can be achieved, and local stress unevenness and local fluctuations therebetween can be reduced, it is able to maximize the circulation efficiency and discharge efficiency of the battery slurry while dispersing and shearing the battery slurry, and reduce the influence of the fluctuation phenomenon of the battery slurry between the deflected blades and the dispersing teeth on the stirring and dispersion effect of the battery slurry.

In some embodiments, a deflection angle between the deflection direction of the dispersing teeth and the radial direction of the stirring impeller is no more than 45°. The embodiment of the present application proposes that the deflection angle between the deflection direction of the dispersing teeth and the radial direction of the stirring impeller is no more than 45°, so that the dispersing teeth are capable of maximizing the circulation efficiency and discharge efficiency of the battery slurry while dispersing and shearing the battery slurry.

In some embodiments, the surrounding plate includes a fixed inner surrounding plate, the fixed inner surrounding plate is arranged around the outer periphery of the blade and is spaced apart from the blade along the radial direction of the stirring impeller. During the operation of the impeller assembly, high shear linear velocity is generated by the high-speed rotation of the blade, and a great velocity gradient is generated at the shearing gap between the fixed inner surrounding plate and the free end of the blade, achieving effective shearing and dispersion effect for materials such as battery slurry.

In some embodiments, the surrounding plate further includes a rotating surrounding plate, the rotating surrounding plate is arranged around the outer periphery of the fixed inner surrounding plate and is spaced apart from the fixed inner surrounding plate along the radial direction of the stirring impeller. During the operation of the impeller assembly, the battery slurry flowing out from the plurality of discharge holes of the fixed inner surrounding plate flows to the shearing gap between the rotating surrounding plate and the fixed inner surrounding plate, and a high shear linear velocity is generated by the high-speed rotation of the rotating surrounding plate, therefore, a great velocity gradient is generated at the shearing gap between the fixed inner surrounding plate and the rotating surrounding plate, thereby achieving the effect of secondary shearing and dispersion of materials such as battery slurry.

In some embodiments, the rotating surrounding plate is connected with a rotating shaft, and the rotation direction of the rotating surrounding plate is consistent with the rotation direction of the stirring impeller. While a driving member (such as a driving motor) drives the rotating shaft to rotate, the rotating surrounding plate can be driven to rotate synchronously through the rotating shaft, which reduces the requirements on the structure and distribution method of the driving member.

In some embodiments, the surrounding plate further includes a fixed outer surrounding plate, the fixed outer surrounding plate is arranged around the outer periphery of the rotating surrounding plate and is spaced apart from the rotating surrounding plate along the radial direction of the stirring impeller. During the operation of the impeller assembly, the gap between the rotating surrounding plate and the fixed outer surrounding plate is small, and the rotating surrounding plate drives the battery slurry to move along the circumferential direction. At this time, the dispersing teeth of the fixed outer surrounding plate disperse and shear the battery slurry in the shearing gap again, and the dispersed and sheared battery slurry flows through the plurality of discharge holes of the fixed outer surrounding plate to the discharge port to form the required battery slurry.

In some embodiments, the gap between the blade and the fixed inner surrounding plate, the gap between the fixed inner surrounding plate and the rotating surrounding plate, and the gap between the rotating surrounding plate and the fixed outer surrounding plate range from 1 mm-3 mm. By comprehensively considering the shearing and dispersion effects of the impeller assembly as well as the torque and temperature rise, setting the gap range to 1 mm-3 mm can achieve the maximum balance in multiple aspects.

In some embodiments, the dispersing teeth of the rotating surrounding plate are arranged parallel to the dispersing teeth of the fixed inner surrounding plate and the dispersing teeth of the fixed outer surrounding plate. The multi-layer dispersing teeth provided in the embodiment of the present application are distributed in parallel, and the multi-layer dispersing teeth distributed in parallel can form multi-layer discharge holes distributed in parallel. Therefore, it is able to reduce the flow resistance of the battery slurry between the multi-layer surrounding plate while dispersing and shearing the battery slurry, and minimize the influence of the dispersing teeth on the circulation and discharge efficiency of the battery slurry.

In some embodiments, the distribution density of the plurality of dispersing teeth on the surrounding plate is arranged to gradually increase from high to low along the height direction of the impeller assembly. Since the density and pressure of the battery slurry are not uniformly distributed along the height direction of the surrounding plate, by arranging the density of the plurality of dispersing teeth to be unevenly distributed along the height direction of the surrounding plate, uniform shearing and dispersion effect of the plurality of dispersing teeth on the upper and lower battery slurry can be achieved.

In some embodiments, the material of the blade and/or the surrounding plate include aluminum alloy. In the embodiment of the present application, under the premise of meeting the strength requirements of the blade and the surrounding plate, the material of the blade and/or the surrounding plate is replaced with aluminum alloy, especially with hard aluminum alloy, so as to avoid the adverse effect on the battery cell caused by mixing metal iron particles into the battery slurry due to wear.

The second aspect of the present application provides mixing and stirring equipment for battery slurry. The mixing and stirring equipment includes: a mixing tank, a material mixing chamber and a discharge port for the battery slurry are formed inside the mixing tank; and the impeller assembly according to the first aspect of the present application, the stirring impeller of the impeller assembly is rotatably arranged in the material mixing chamber, and the surrounding plate of the impeller assembly is provided at the discharge port.

In this embodiment, the mixing and stirring equipment has all the technical effects of the impeller assembly. The mixing and stirring equipment is provided with a plurality of dispersing teeth on the impeller assembly, which not only ensures the stirring of materials such as battery slurry, but also effectively disperses the battery slurry after stirring.

The above description is only a summary of the technical solutions of the present application. In order to be able to understand the technical means of the present application more clearly, the technical means can be implemented according to the content of the specification. Furthermore, to make the above and other objectives, features and advantages of the present application more comprehensible, specific implementations of the present application are exemplified below.

### DESCRIPTION OF DRAWINGS

Various other advantages and benefits will become apparent to those of ordinary skill in the art upon reading the following detailed description of the preferred implementations. The drawings are for the purpose of illustrating the preferred implementations only and are not to be considered a limitation to the present application. Also, the same components are denoted by the same reference numerals throughout the drawings. In the drawings:

FIG. 1 is a schematic structural diagram of an impeller assembly according to some embodiments of the present application;

FIG. 2 is a front view of the impeller assembly shown in FIG. 1;

FIG. 3 is a sectional view in A-A direction of the impeller assembly shown in FIG. 2;

FIG. 4 is a schematic diagram of a partial structure of the impeller assembly shown in FIG. 3.

Some of the reference numerals in detailed description are as follows:
100 impeller assembly;
10 stirring impeller;
11 rotating shaft;
12 blades;
20 surrounding plate,
201 dispersing teeth,
202 discharge hole,
21 fixed inner surrounding plate,
22 rotating surrounding plate,
23 fixed outer surrounding plate.

### DETAILED DESCRIPTION

Embodiments of the technical solutions of the present application will be described in detail below in conjunction with the drawings. The following embodiments are only used to more clearly illustrate the technical solution of the present application, and therefore are only used as examples and cannot be used to limit the scope of protection of the present application.

Unless otherwise defined, all technical and scientific terms used herein have the same meaning as commonly understood by those skilled in the art belonging to the technical field of the present application; the terms used herein are intended only for the purpose of describing specific embodiments and are not intended to limit the present application; the terms “including” and “having” and any variations thereof in the specification and the claims of the present application and in the description of drawings above are intended to cover non-exclusive inclusion.

In the description of the embodiments of the present application, the technical terms “first”, “second”, and the like are used only to distinguish between different objects, and are not to be understood as indicating or implying a relative importance or implicitly specifying the number, particular order, or primary and secondary relation of the technical features indicated. In the description of the embodiments of the present application, the meaning of “a plurality of” is two or more, unless otherwise explicitly and specifically defined.

Reference herein to “an embodiment” means that a particular feature, structure, or characteristic described in connection with the embodiment can be included in at least one embodiment of the present application. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

In the description of the embodiments of the present application, the term “and/or” is only an association relationship for describing associated objects, indicating that there may be three relationships, for example A and/or B may represent three situations: A exists alone, both A and B exist, and B exists alone. In addition, the character “/” herein generally means that the associated objects before and after it are in an “or” relationship.

In the description of the embodiments of the present application, the term “a plurality of” refers to two or more (including two), and similarly, “multiple groups” refers to two or more (including two) groups, and “multiple sheets” refers to two or more (including two) sheets.

In the description of the embodiments of the present application, the orientation or position relationship indicated by the technical terms “center”, “longitudinal”, “transverse”, “length”, “width”, “thickness”, “upper,” “lower,” “front,” “back,” “left,” “right,” “vertical,” “horizontal,” “top,” “bottom,” “inner,” “outer,” “clockwise,” “counterclockwise,” “axial”, “radial”, “circumferential”, etc. are based on the orientation or position relationship shown in the drawings and are intended to facilitate the description of the embodiments of the present application and simplify the description only, rather than indicating or implying that the device or element referred to must have a particular orientation or be constructed and operated in a particular orientation, and therefore are not to be interpreted as limitations on the embodiments of the present application.

In the description of the embodiments of the present application, unless otherwise expressly specified and limited, the technical terms “mount,” “join,” “connect,” “fix,” etc. should be understood in a broad sense, such as, a fixed connection, a detachable connection, or an integral connection; a mechanical connection, or an electrical connection; a direct connection, an indirect connection through an intermediate medium, an internal connection of two elements, or interaction between two elements. For those of ordinary skill in the art, the specific meanings of the above terms in the embodiments of the present application can be understood according to specific situations.

As an energy supply device commonly used in various electronic products, batteries are experiencing rapid growth in development and demand in technical fields such as electric vehicles and energy storage equipment.

In the battery manufacturing process, battery processing procedures such as battery slurry stirring are required. The existing battery slurry stirring process adopts an impeller surrounding-plate-type stator-rotor structure design. A high shear linear velocity is generated by a high-speed rotation of the rotor, and a great velocity gradient is generated in the gap between the stator and the rotor, achieving the effect of effective shearing and dispersion of materials. However, the effective shearing area of the battery slurry stirring process is only in the meshing gap between teeth of the stator and rotor, and the effective shearing area for the battery slurry is small, resulting in low dispersion efficiency of the battery slurry.

In addition, the battery slurry stirring process also has requirements on the circulation efficiency of the battery slurry. The stator, rotor and surrounding plate cannot hinder the movement of the battery slurry, making it difficult to discharge the battery slurry. Moreover, if the battery slurry is forced to accelerate and discharge by adding discharge blades on the outer side of the surrounding plate, the pressure in the discharge chamber will fluctuate greatly, causing pulsation of the discharge flow, and reducing the dispersion effect of the battery slurry.

The existing battery slurry stirring process and battery slurry stirring equipment cannot efficiently balance the stirring of battery materials and the dispersion of battery material.

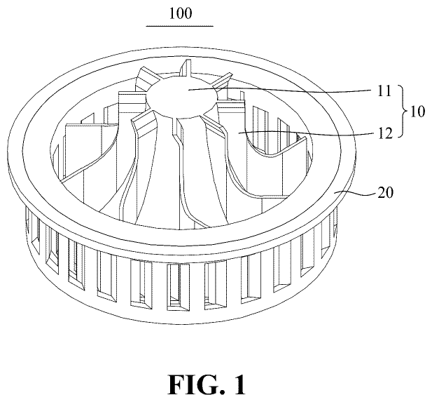

As shown in FIG. 1 to FIG. 4, in order to solve the technical problem that existing battery slurry stirring equipment cannot efficiently balance stirring and dispersion of battery material, the first aspect of the present application provides an impeller assembly 100. The impeller assembly 100 includes a stirring impeller 10 and a surrounding plate 20. The stirring impeller 10 includes a rotating shaft 11 and blades 12 arranged around the rotating shaft 11 along the circumferential direction, the surrounding plate 20 is arranged around the outer periphery of the stirring impeller 10, and the surrounding plate 20 is provided with a plurality of discharge holes 202, the surrounding plate 20 further includes a plurality of dispersing teeth 201, the plurality of dispersing teeth 201 are arranged facing the rotation direction of the blades 12, and the plurality of dispersing teeth 201 are distributed around the periphery of the plurality of discharge holes 202.

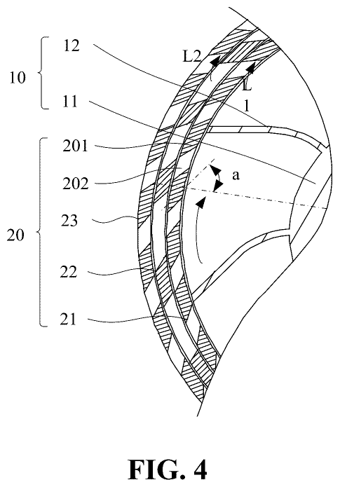

Specifically, the surrounding plate 20 is provided with a plurality of dispersing teeth 201 facing the rotation direction of the stirring impeller 10 (for example, in FIG. 4, _{L1} is the rotation direction of the stirring impeller 10), the plurality of dispersing teeth 201 are distributed around the plurality of discharge holes 202, that is to say the plurality of dispersing teeth 201 are distributed at intervals and the plurality of discharge holes 202 are formed between the plurality of dispersing teeth 201.

In this embodiment, an operation of the impeller assembly 100 is described in detail in conjunction with an application scenario of an embodiment of the impeller assembly 100: the impeller assembly 100 is applied to mixing and stirring equipment for battery slurry, the mixing and stirring equipment includes a mixing tank. A material mixing chamber and a discharge port for battery slurry are formed inside the mixing tank. The stirring impeller 10 of the impeller assembly 100 is rotatably arranged in the material mixing chamber, the surrounding plate 20 of the impeller assembly 100 is arranged at the discharge port and is arranged around the outer periphery of the stirring impeller 10. After the battery material is added into the material mixing chamber, the driving member of the mixing and stirring equipment drives the stirring impeller 10 to rotate, and the stirring impeller 10 stirs the battery material and battery solvent, thereby producing preliminary battery slurry.

In the process of stirring the battery slurry by the stirring impeller 10, the blades 12 of the stirring impeller 10 exert an outward centrifugal force on the battery slurry, and the battery slurry is thrown to the positions of the plurality of dispersing teeth 201 and the plurality of discharge holes 202 under the action of centrifugal force. Since the plurality of dispersing teeth 201 are arranged to face the rotation direction of the stirring impeller 10, the battery slurry can hit the plurality of dispersing teeth 201 at a large extent, and a “flow separation phenomenon” occurs at the plurality of dispersing teeth 201: part of battery slurry can flow out to the discharge port of the mixing tank through the surrounding plate 20 along the plurality of discharge holes 202 between the plurality of dispersing teeth 201; the other part of the battery slurry can flow back to the mixing chamber along the plurality of dispersing teeth 201. On the one hand, the refluxed battery slurry improves the turbulence of the battery slurry inside the mixing chamber, and on the other hand, the refluxed battery slurry can be thrown to the plurality of dispersing teeth 201 again under the drive of the stirring impeller 10 and subjected to a second shear, thereby effectively enhancing and improving the dispersion effect of the battery slurry.

That is to say, the impeller assembly 100 proposed in the embodiment of the present application is capable of dispersing the battery slurry by a plurality of dispersing teeth 201 between the stirring impeller 10 and the surrounding plate 20, so as to reduce the phenomenon that some particle agglomerates in the battery slurry flow to the discharge port through the surrounding plate 20 without being dispersed and separated.

It should be noted that the embodiment of the present application does not limit the structure and distribution method of the surrounding plate 20 and the dispersing teeth 201, because the surrounding plate 20 can be a complete annular structure arranged around the outer periphery of the stirring impeller 10, alternatively, it can be an arc-shaped structure or a semi-annular structure arranged around the periphery of the stirring impeller 10, as long as the surrounding plate 20 can block the stirring impeller 10 and the discharge port to some extent. The specific distribution range of the surrounding plate 20 is not specifically limited here. Moreover, the outer periphery of the stirring impeller 10 may be surrounded by a layer of surrounding plate 20 or a multi-layer surrounding plate 20. The multi-layer surrounding plate 20 includes a fixed surrounding plate, a rotating surrounding plate 22 or a combination of a fixed surrounding plate and a rotating surrounding plate 22. These adjustments all fall within the protection scope of the embodiments of the present application.

In addition, the specific structure of the dispersing teeth 201 is not limited to the “teeth” structure in the traditional sense, and it can be arranged as grid bars, punched pieces, protrusions, or intervals between holes formed by punching on the surrounding plate 20, all of which fall within the protection scope of the present application. In the embodiment of the present application, the dispersing teeth 201 are arranged as “facing the rotation direction”, which includes the situation that the dispersing teeth 201 extend completely to the stirring area of the stirring impeller 10 and are staggered from the blades 12. It also includes the situation that the dispersing teeth 201 are embedded in the surrounding plate 20, and the portion of the dispersing teeth 201 located in the surrounding plate 20 is provided with a tooth surface that “facing the rotation direction”, moreover, “facing” indicates the inclination angle α of the dispersing teeth 201 (as shown in FIG. 4), indicating that the angle between the inclination direction of the dispersing teeth 201 and the “rotation direction” (shown as L₁ in FIG. 4) is an acute angle or right angle.

Further, the distribution method of the plurality of dispersing teeth 201 on the surrounding plate 20 includes distribution along the circumferential direction and the height direction of the surrounding plate 20, and since the density and pressure of the battery slurry are not uniformly distributed along the height direction of the surrounding plate 20, in order to improve the uniform shearing and dispersion effect of the plurality of dispersing teeth 201 on the upper and lower battery slurry, it is preferable to arrange the density of the plurality of dispersing teeth 201 to be consistent with the density and pressure of the battery slurry. For example, the density of the plurality of dispersing teeth 201 is arranged to be unevenly distributed along the height direction of the surrounding plate 20. For example, more dispersing teeth 201 are provided at the bottom of the battery slurry where the density and pressure are higher, and fewer dispersing teeth 201 are provided at the top of the battery slurry where the density and pressure are lower, and the purpose of evenly shearing and dispersing the unevenly distributed battery slurry is achieved through a plurality of unevenly distributed dispersing teeth 201.

It can be seen that arranging a plurality of dispersing teeth 201 on the impeller assembly 100 provided in the embodiment of the present application not only ensures the stirring of materials such as battery slurry, but also effectively disperses the battery slurry after stirring. Specifically, when the battery slurry is dispersed under the relative movement between the blades 12 and the surrounding plate 20, while maintaining a high shear strength, the plurality of dispersing teeth 201 on the surrounding plate 20 can serve to cut particle groups through head-on collision with the particle groups, causing strong impact and disturbance to the particle agglomerates in the suspension, so that the battery slurry is fully mixed in the plurality of discharge holes 202 on the surrounding plate 20, which is conducive to improving the dispersion effect on nano-scale material and high-solid content formulation. Therefore, the impeller assembly 100 provided in this embodiment is able to fully mix and disperse the battery slurry through the plurality of dispersing teeth 201, reducing the phenomenon that part of battery slurry is not fully mixed and dispersed after passing through the impeller assembly 100.

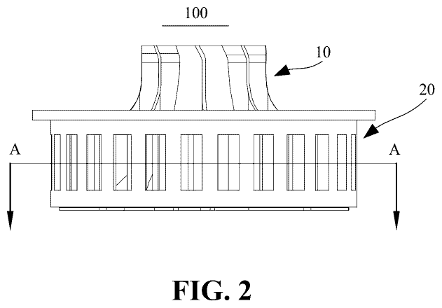

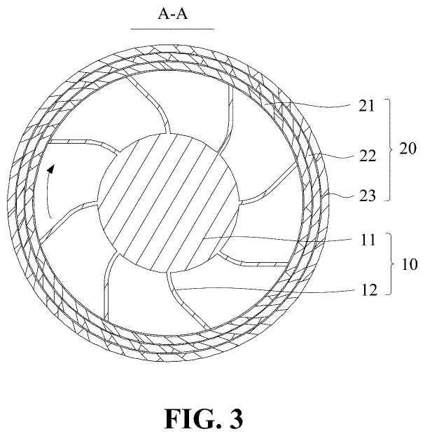

As shown in FIG. 2 and FIG. 3, in some embodiments, the surrounding plate 20 includes a grid plate disposed around the periphery of the stirring impeller 10, the dispersing teeth 201 include grid bars arranged on the grid plate, and side faces of the grid bars along the circumferential direction are arranged to face the rotation direction.

In this embodiment, the grid plate is provided with a plurality of grid bars distributed along the circumferential direction and/or height direction of the grid plate, and the plurality of grid bars are embedded in the annular wall of the grid plate, and a plurality of grid holes are formed between the plurality of grid bars, so that the plurality of grid bars can disperse and shear the battery slurry entering the plurality of grid holes.

Specifically, the grid plate is arranged as a cylindrical structure as a whole, and then the grid bars and grid holes are formed by punching holes in the annular wall of the grid plate, and the grid bars and grid holes are alternately distributed along the circumference of the grid plate. An integral grid bar and grid hole can be arranged along the height direction of the grid plate. The width of the integral grid bar and grid hole is consistent along the height direction of the grid plate, or the width of the integral grid bar and grid hole is gradually decreased or increased along the height direction of the grid plate. Further, a plurality of grid bars and grid holes distributed at intervals may be provided along the height direction of the grid plate. The length and width of the plurality of grid bars and grid holes distributed at intervals may be arranged to be consistent with each other, or may be arranged to decrease or increase gradually. The specific distribution method and size of the grid bars and grid holes are determined according to the density and pressure of the battery slurry, which will not be described in detail here.

In addition, the overall structure of the grid plate is similar to a fence or a hedge structure. The specific structure of the grid bars includes a vertical strip structure or a cross structure, and the specific structure of the grid holes includes vertical strip holes, rhombus holes or rectangular holes. These structures all fall within the protection scope in the embodiments of the present application.

It can be seen that the embedded dispersing teeth 201 provided in the embodiment of the present application, compared with the dispersing teeth protruding from the annular wall of the grid plate, the embedded dispersing teeth 201 have the advantage of acting on the battery slurry inside the surrounding plate 20. As a result, they can minimize the influence on the circulation efficiency and discharge efficiency of the battery slurry while dispersing and shearing the battery slurry.

As shown in FIG. 1 and FIG. 3, in some embodiments, the blade 12 are provided as deflected blades that are reversely deflected with respect to the rotation direction of the stirring impeller 10, and the deflection direction of the dispersing teeth 201 is arranged to be perpendicular or parallel to the deflected blades.

In this embodiment, the blade 12 includes a connecting portion and a free end, the connecting portion is arranged at the root portion of the blade 12 and connected with the rotating shaft 11, and the free end is arranged at a position away from the root portion of the blade 12 playing the role of stirring materials such as battery slurry. The centrifugal force and shear force exerted on the battery slurry are generated by the relative movement between the free end and the surrounding plate 20.

As proposed in the embodiment of the present application, arranging the blade 12 as a deflected blade is to arrange the free end of the blade 12 and/or a portion close to the free end of the blade 12 as a deflected structure, and the reverse backward deflection angle range of the free end of the blade 12 and/or the portion close to the free end is 30°-45°, and there are 6-8 pieces of blade 12. Under a same rotational speed of the stirring impeller 10, the backward deflected blade 12 not only increases an interaction area between the blade 12 and the battery slurry, but also provides a buffering effect on the interaction force between the blade 12 and the battery slurry, which is conducive to improving the operation stability and discharge efficiency of the stirring impeller 10.

As proposed in the embodiment of the present application, the deflection direction of the dispersing teeth 201 is arranged to be perpendicular or parallel to the deflected blade, that is, the free end of the blade 12 and/or the portion of the blade 12 close to the free end is arranged to be perpendicular or parallel to the dispersing teeth 201. By arranging the deflection direction of the dispersing teeth 201 to be perpendicular or parallel to the deflected blades, relatively balanced distribution of force between the deflected blades and the dispersing teeth 201 can be achieved, and local stress unevenness and local fluctuations therebetween can be reduced, it is able to maximize the circulation efficiency and discharge efficiency of the battery slurry while dispersing and shearing the battery slurry, and reduce the influence of the fluctuation phenomenon of the battery slurry between the deflected blades and the dispersing teeth 201 on the stirring and dispersion effect of the battery slurry.

As shown in FIG. 4, in some embodiments, the deflection angle a between the deflection direction of the dispersing teeth 201 and the radial direction of the stirring impeller 10 is no more than 45°.

In this embodiment, the deflection angle between the deflection direction of the dispersing teeth 201 and the radial direction of the stirring impeller 10 is the angle between an inclination direction of the center line of the dispersing teeth 201 and the radial direction of the stirring impeller 10. The deflection angle between the deflecting direction of the dispersing teeth 201 and the radial direction of the stirring impeller 10 can represent the effective facing area between the dispersing teeth 201 and the rotation direction of the stirring impeller 10. The deflection angle of the dispersing teeth 201 not only needs to ensure the collision and dispersion effect of the dispersing teeth 201 on materials such as battery slurry, but also needs to minimize the influence on the circulation efficiency of the battery slurry.

Therefore, setting the deflection angle of the dispersing teeth 201 to 45° enables the dispersing teeth 201 to have a large projection surface in the rotation direction of the stirring impeller 10, so as to improve the collision and dispersion effect of the dispersing teeth 201 on materials such as battery slurry. If the deflection angle of the dispersing teeth 201 is set to more than 45°, the increase in the deflection angle of the dispersing teeth 201 will cause the dispersing teeth 201 to apply a reverse pushing force on materials such as battery slurry towards the stirring impeller 10, hindering normal discharge of materials such as battery slurry in the direction of the surrounding plate 20 and affecting the circulation efficiency and discharge efficiency of the battery slurry.

Therefore, the embodiment of the present application proposes that the deflection angle between the deflection direction of the dispersing teeth 201 and the radial direction of the stirring impeller 10 is no more than 45°, so that the dispersing teeth 201 are capable of maximizing the circulation efficiency and discharge efficiency of the battery slurry while dispersing and shearing the battery slurry.

As shown in FIG. 3 and FIG. 4, in some embodiments, the surrounding plate 20 includes a fixed inner surrounding plate 21, the fixed inner surrounding plate 21 is arranged around the outer periphery of the blade 12 and is radially spaced apart from the blade 12.

In this embodiment, the outer periphery of the stirring impeller 10 may be surrounded by a layer of surrounding plate 20 or a multi-layer surrounding plate 20. The multi-layer surrounding plate 20 includes a fixed surrounding plate, a rotating surrounding plate 22 or a combination of a fixed surrounding plate and a rotating surrounding plate 22. In the case where a multi-layer surrounding plate 20 is arranged around the out periphery of the stirring impeller 10, the fixed inner surrounding plate 21 is located at the innermost side of the multi-layer surrounding plate 20 and is closely attached to the free end of the blade 12, and there is a shearing gap between the fixed inner surrounding plate 21 and the free end of the blade 12.

During the operation of the impeller assembly 100, high shear linear velocity is generated by the high-speed rotation of the blade 12, and a great velocity gradient is generated at the shearing gap between the fixed inner surrounding plate 21 and the free end of the blade 12, then, an effective shearing and dispersion of materials such as battery slurry is achieved through the dispersing teeth 201.

As shown in FIG. 3 and FIG. 4, in some embodiments, the surrounding plate 20 further includes a rotating surrounding plate 22, the rotating surrounding plate 22 is arranged around the outer periphery of the fixed inner surrounding plate 21 and is spaced apart from the fixed inner surrounding plate 21 along the radial direction of the stirring impeller 10.

In this embodiment, the outer periphery of the stirring impeller 10 may be surrounded by a layer of surrounding plate 20 or a multi-layer surrounding plate 20. The multi-layer surrounding plate 20 includes a fixed surrounding plate, a rotating surrounding plate 22 or a combination of a fixed surrounding plate and a rotating surrounding plate 22. In the case where a multi-layer surrounding plate 20 is arranged around the out periphery of the stirring impeller 10, the fixed inner surrounding plate 21 is located at the innermost side of the multi-layer surrounding plate 20 and is placed close to the free end of the blade 12, the rotating surrounding plate 22 is located in the middle of the multi-layer surrounding plate 20 and is closely attached to the fixed inner surrounding plate 21, and there is a shearing gap between the rotating surrounding plate 22 and the fixed inner surrounding plate 21.

During the operation of the impeller assembly 100, the battery slurry flowing out from the plurality of discharge holes 202 of the fixed inner surrounding plate 21 flows to the shearing gap between the rotating surrounding plate 22 and the fixed inner surrounding plate 21, and a high shear linear velocity is generated by the high-speed rotation of the rotating surrounding plate 22. In FIG. 4, L₂ is the rotation direction of the rotating surrounding plate 22. A great velocity gradient is generated at the shearing gap between the fixed inner surrounding plate 21 and the rotating surrounding plate 22, thereby achieving the effect of secondary shearing and dispersion of materials such as battery slurry through the dispersing teeth 201.

As shown in FIG. 4, in some embodiments, the rotating surrounding plate 22 is connected with a rotating shaft 11, and the rotation direction of the rotating surrounding plate 22 is consistent with the rotation direction of the stirring impeller 10.

In this embodiment, while a driving member (such as a driving motor) drives the rotating shaft 11 to rotate, the rotating surrounding plate 22 can be driven to rotate synchronously through the rotating shaft 11, and a gap is provided between the rotating shaft 11 and the rotating surrounding plate 22 along the radial direction of the impeller assembly 100, and the fixed inner surrounding plate 21 is arranged at the gap between blade 12 and the rotating surrounding plate 22, the inner and outer side walls of the fixed inner surrounding plate 21 are respectively fitted with blade 12 and the rotating surrounding plate 22 to form a shearing gap for materials such as battery slurry.

The deflection direction of the dispersing teeth 201 of the rotating surrounding plate 22 is perpendicular to or opposite to the rotation direction of the blade 12, and the inclination angle of the dispersing teeth 201 of the rotating surrounding plate 22 is less than 45°. Under the same rotational speed, the phenomenon that the dispersing teeth 201 of the rotating surrounding plate 22 exert a reverse pushing force on materials such as battery slurry towards the stirring impeller 10 can be reduced, so as to enable the battery slurry to obtain higher circulation efficiency and discharge efficiency under driven by the impeller assembly 100.

As shown in FIG. 3 and FIG. 4, in some embodiments, the surrounding plate 20 further includes a fixed outer surrounding plate 23, the fixed outer surrounding plate 23 is arranged around the periphery of the rotating surrounding plate and is radially spaced apart from the rotating surrounding plate.

In this embodiment, the outer periphery of the stirring impeller 10 may be surrounded by a layer of surrounding plate 20 or a multi-layer surrounding plate 20. The multi-layer surrounding plate 20 includes a fixed surrounding plate 20, a rotating surrounding plate 22 or a combination of a fixed surrounding plate 20 and a rotating surrounding plate 22. In the case where a multi-layer surrounding plate 20 is arranged around the out periphery of the stirring impeller 10, the fixed inner surrounding plate 21 is located at the innermost side of the multi-layer surrounding plate 20 and is closely attached to the free end of the blade 12. The rotating surrounding plate 22 is located in the middle of the multi-layer surrounding plate 20 and is closely attached to the fixed inner surrounding plate 21, and there is a shearing gap between the rotating surrounding plate 22 and the fixed inner surrounding plate 21, the fixed outer surrounding plate 23 is located at the outermost side of the multi-layer surrounding plate 20 and is closely attached to the rotating surrounding plate 22, and there is a shearing gap between the rotating surrounding plate 22 and the fixed outer surrounding plate 23.

During the operation of the impeller assembly 100, the battery slurry enters the shearing gap between the rotating surrounding plate 22 and the fixed inner surrounding plate 21 from the material mixing chamber. The driving member drives the rotating surrounding plate 22 to rotate, and the gap between the rotating surrounding plate 22 and the fixed inner surrounding plate 21 is small, the rotating surrounding plate 22 drives the battery slurry to move in the circumferential direction. At this time, the dispersing teeth 201 on the rotating surrounding plate 22 disperse and shear the battery slurry in the shearing gap. Then dispersed and sheared battery slurry flows to the shearing gap between the rotating surrounding plate 22 and the fixed outer surrounding plate 23 through a plurality of discharge holes 202 on the rotating surrounding plate 22, the driving member drives the rotating surrounding plate 22 to rotate, and the gap between the rotating surrounding plate 22 and the fixed outer surrounding plate 23 is small, the rotating surrounding plate 22 drives the battery slurry to move in the circumferential direction, at this time, the dispersing teeth 201 of the fixed outer surrounding plate 23 disperse and shear the battery slurry in the shearing gap again, and the dispersed and sheared battery slurry flows to the discharge port through the plurality of discharge holes 202 on the fixed outer surrounding plate 23 and form the desired battery slurry.

It should be noted that, in some other embodiments of the present application, a plurality of shearing gaps may be continuously provided along the radial direction of the impeller 10, and a surrounding plate 20 is arranged between adjacent shearing gaps. The fixed surrounding plate and the rotating surrounding plate 22 are alternately distributed. Under the action of centrifugal force generated by the rotating surrounding plate 22 and the squeezing force from the subsequent battery slurry, the battery slurry in a shearing gap is transferred from a plurality of discharge holes 202 on the previous surrounding plate 20 to the next shearing gap, thereby further shearing and dispersing the battery slurry, and finally achieving the purpose of fully dispersing the battery slurry.

As shown in FIG. 4, in some embodiments, the gap between the blade 12 and the fixed inner surrounding plate 21, the gap between the fixed inner surrounding plate 21 and the rotating surrounding plate 22, and the gap between the rotating surrounding plate 22 and the fixed outer surrounding plate 23 range from 1 mm-3 mm.

In this embodiment, the meshing gap between the blade 12 and the surrounding plate 20 and the meshing gap between adjacent surrounding plates 20 are selected according to the state and dispersion effect of the battery slurry, and the range is generally between 1 mm-3 mm. The smaller the meshing gap between the blade 12 and the surrounding plate 20 and between adjacent surrounding plates 20, the better the shearing and dispersion effect of the battery slurry can be achieved through the impeller assembly 100. However, the greater the operation torque of the impeller assembly 100 is, the higher the local temperature rise of the impeller assembly 100. Therefore, by comprehensively considering the shearing and dispersion effects of the impeller assembly 100 as well as the torque and temperature rise, setting the gap range to 1 mm-3 mm can achieve the maximum balance in multiple aspects.

As shown in FIG. 4, in some embodiments, the dispersing teeth 201 of the rotating surrounding plate 22 are arranged parallel to the dispersing teeth 201 of the fixed inner surrounding plate 21 and the dispersing teeth 201 of the fixed outer surrounding plate 23.

In this embodiment, the fixed inner surrounding plate 21, the rotating surrounding plate 22 and the fixed outer surrounding plate 23 are arranged in similar structures, the difference among them is that they have different inner diameters, so as to achieve the purpose of arranging the fixed inner surrounding plate 21, the rotating surrounding plate 22 and the fixed outer surrounding plate 23 from inside to outside in sequence. The structure and distribution method of the plurality of dispersing teeth 201 on the fixed inner surrounding plate 21, the rotating surrounding plate 22 and the fixed outer surrounding plate 23 are also the same, so as to achieve the purpose of parallel distribution of the multi-layer dispersing teeth 201 of the multi-layer surrounding plate 20.

The multi-layer dispersing teeth 201 provided in the embodiment of the present application are distributed in parallel, and the multi-layer dispersing teeth 201 distributed in parallel can form multi-layer discharge holes 202 distributed in parallel. Therefore, it is able to reduce the flow resistance of the battery slurry between the multi-layer surrounding plate 20 while dispersing and shearing the battery slurry, and minimize the influence of the dispersing teeth 201 on the circulation and discharge efficiency of the battery slurry.

In some embodiments, the distribution density of the plurality of dispersing teeth 201 on the surrounding plate 20 is arranged to gradually increase from high to low along the height direction of the impeller assembly 100.

In this embodiment, an integral dispersing teeth 201 and deflection hole may be provided along the height direction of the surrounding plate 20, and the width of the integral dispersing teeth 201 and the deflection hole is consistent along the height direction of the surrounding plate 20, or the width of the integral dispersing teeth 201 and the deflection hole is gradually decreased or increased along the height direction of the surrounding plate 20. Further, a plurality of dispersing teeth 201 and deflection holes distributed at intervals may be provided along the height direction of the surrounding plate 20. The length and width of the plurality of dispersing teeth 201 and deflection holes distributed at intervals may be arranged to be consistent with each other, or may be arranged to decrease or increase gradually. The specific distribution and size of the grid bars and grid holes are determined according to the density and pressure of the battery slurry, which will not be described in detail here.

Since the density and pressure of the battery slurry are not uniformly distributed along the height direction of the surrounding plate 20, in order to improve the uniform shearing and dispersion effect of the plurality of dispersing teeth 201 on the upper and lower battery slurry, it is preferable to arrange the density of the plurality of dispersing teeth 201 to be unevenly distributed along the height direction of the surrounding plate 20. For example, more dispersing teeth 201 are provided at the bottom of the battery slurry where the density and pressure are higher, and fewer dispersing teeth 201 are provided at the top of the battery slurry where the density and pressure are lower, and the purpose of evenly shearing and dispersing the unevenly distributed battery slurry is achieved through a plurality of unevenly distributed dispersing teeth 201.

In some embodiments, the material of the blade 12 and/or the surrounding plate include aluminum alloy.

In this embodiment, the existing blade 12 and/or surrounding plate 20 are generally made of stainless steel that meets the structural strength requirements at an operation speed. The stainless steel blade 12 and/or surrounding plate 20 do not react with the battery slurry and will not have adverse effects on the battery slurry during mixing and dispersing. However, during the process of dispersing the battery slurry by the dispersing teeth 201, the wear between the battery slurry and the wall surface of the blade 12 and/or the surrounding plate 20 will lead to mixing of metal iron particles into the battery slurry, causing a series of problems in the manufactured battery cell.

Therefore, in the embodiment of the present application, under the premise of meeting the strength requirements of the blade 12 and the surrounding plate 20, the material of the blade 12 and/or the surrounding plate 20 is replaced with aluminum alloy, especially with hard aluminum alloy, so as to avoid the adverse effect on the battery cell caused by mixing metal iron particles into the battery slurry due to wear.

As shown in FIG. 1 to FIG. 4, a preferred embodiment of the impeller assembly 100 of the present application is provided: the impeller assembly 100 includes a rotating shaft 11, blades 12, a fixed inner surrounding plate 21, a rotating surrounding plate 22 and a fixed outer surrounding plate 23 distributed sequentially from inside to outside, the rotating shaft 11, the blades 12, and the rotating surrounding plate 22 form an integrated rotor structure, the fixed inner surrounding plate 21 and the fixed outer surrounding plate 23 form an integrated stator structure, the circumferential surface of the rotating shaft 11 is evenly distributed with 6-8 deflected blades, the deflection direction of the deflected blades is opposite to the deflection direction of the dispersing teeth 201 on the rotating surrounding plate 22, the rotating surrounding plate 22 and the rotating shaft 11 are connected together at the bottom of the impeller assembly 100 to rotate.

The stator structure is composed of a fixed inner surrounding plate 21 and a fixed outer surrounding plate 23, which are evenly distributed on inner and outer sides of the rotating surrounding plate 22 respectively, both the fixed inner surrounding plate 21 and the fixed outer surrounding plate 23 are provided with dispersing teeth 201. During the operation of the impeller assembly 100, the battery slurry passes through the blades 12, a gap channel between the free end of the blades 12 and the fixed inner surrounding plate 21, a gap channel between the fixed inner surrounding plate 21 and the rotating surrounding plate 22, and a gap channel between the rotating surrounding plate 22 and the fixed outer surrounding plate 23 in sequence, and finally flow to a discharge port of the mixing tank via a plurality of discharge holes 202 on the fixed outer surrounding plate 23.

The impeller assembly 100 provided in the embodiment of the present application enables the battery slurry to undergo a strong shearing and dispersion due to a huge speed difference in the narrow gap when passes through the gap channel. At the same time, since the dispersing teeth 201 in the gap channel adopt an “inverse tooth” structure design, when the battery slurry flows through the plurality of discharge holes 202 between the plurality of dispersing teeth 201, it will collide with the wall surface of the dispersing teeth 201 and cause flow separation, causing secondary shearing of the battery slurry, which improves the shearing and dispersion effect of the battery slurry.

The second aspect of the present application provides mixing and stirring equipment for battery slurry. The mixing and stirring equipment includes a mixing tank and an impeller assembly 100, a material mixing chamber and a discharge port for the battery slurry are formed inside the mixing tank; the impeller assembly 100 is the impeller assembly 100 according to the first aspect of the present application, a stirring impeller 10 of the impeller assembly 100 is rotatably arranged in the material mixing chamber, and a surrounding plate 20 of the impeller assembly 100 is provided at the discharge port.

In this embodiment, the mixing and stirring equipment has all the technical effects of the impeller assembly 100. The mixing and stirring equipment is provided with a plurality of dispersing teeth 201 on the impeller assembly 100, which not only ensures the stirring of materials such as battery slurry, but also effectively disperses the battery slurry after stirring.

In addition, it should be noted that the mixing and stirring equipment not only includes the mixing and stirring equipment for battery slurry, but also includes the mixing and stirring equipment for other slurries or materials. The embodiments of the present application only focus on the structures related to the invention of the mixing and stirring equipment, and do not mean that the mixing and stirring equipment only has these structures. For example, the mixing and stirring equipment also includes devices for a feeding stage and a circulation stage. In the feeding stage, the battery powder in the feeding bin is continuously added to a feeding device and fed into the material mixing chamber of the mixing tank through the feeding device. Meanwhile, the solvent in the mixing tank is transferred via a pipeline to the material mixing chamber, and the impeller assembly 100 stirs the battery powder so that the battery powder is fully fused with the solvent, then they are fed into a dispersing gap between the impeller assembly 100 and the surrounding plate 20, and the dispersing teeth 201 disperse the battery slurry in the dispersing gap. The dispersed battery slurry is transferred via the pipeline to the mixing tank by a circulating pump, the impeller assembly 100 further stirs the battery slurry, then the stirred battery slurry is re-fed into the dispersing gap between the impeller assembly 100 and the surrounding plate 20 by the circulating pump.

In the above manner, the battery slurry is circulated in the mixing tank, and the number of cycles is not limited until the end of feeding. In the circulation stage, the feeding device stops adding battery powder into the mixing tank, and the battery slurry circulates between the mixing chamber and the dispersing gap. The stirring and dispersion of the battery slurry are stopped until various parameters of the battery slurry meet requirements. By processing the battery slurry in a circular treatment manner, excessive temperature rise caused by long time stirring of the battery slurry in a single device can be avoided, the solid content of the slurry can be increased and processing efficiency of the slurry can be improved; in addition, the usage of NMP (N-methylpyrrolidone) in the production of battery slurry and the energy consumption of coating equipment can be reduced caused be the increase in the solid content of the battery slurry, the production cost of the battery can be reduced.

Finally, it should be noted that the above embodiments are merely used for illustrating rather than limiting the technical solutions of the present application. Although the present application has been described in detail with reference to the above various embodiments, those of ordinary skill in the art should understand that the technical solutions specified in the above various embodiments can still be modified, or some or all of the technical features therein can be equivalently substituted; and such modifications or substitutions do not make the essence of the corresponding technical solutions depart from the scope of the technical solutions of the various embodiments of the present application, which shall fall within the scope of the claims and the specification of the present application. In particular, the technical features mentioned in the various embodiments can be combined in any manner as long as there is no structural conflict. The present application is not limited to the specific embodiments disclosed herein, but rather includes all technical solutions falling within the scope of the claims.

What is claimed is:

1. An impeller assembly, the impeller assembly comprising:
a stirring impeller, the stirring impeller comprising a rotating shaft and blades arranged around the rotating shaft along the circumferential direction; and
a surrounding plate, the surrounding plate being arranged around the outer periphery of the stirring impeller, and the surrounding plate being provided with a plurality of discharge holes, the surrounding plate further including a plurality of dispersing teeth, the plurality of dispersing teeth being arranged facing a rotation direction of the blades, and the plurality of dispersing teeth being distributed around the periphery of the plurality of discharge holes.

2. The impeller assembly according to claim 1, wherein the surrounding plate comprises a grid plate disposed around the periphery of the stirring impeller, the dispersing teeth comprise grid bars arranged on the grid plate, and side faces of the grid bars along the circumferential direction are arranged to face the rotation direction.

3. The impeller assembly according to claim 1, wherein the blades are arranged as deflected blades reversely deflected with respect to the rotation direction of the stirring impeller, and the deflection direction of the dispersing teeth is arranged to be perpendicular or parallel to the deflected blades.

4. The impeller assembly according to claim 1, wherein a deflection angle between the deflection direction of the dispersing teeth and the radial direction of the stirring impeller is no more than 45°.

5. The impeller assembly according to claim 1, wherein the surrounding plate comprises a fixed inner surrounding plate, and the fixed inner surrounding plate is arranged around the outer periphery of the blades and is spaced apart from the blades along the radial direction of the stirring impeller.

6. The impeller assembly according to claim 5, wherein the surrounding plate further comprises a rotating surrounding plate, and the rotating surrounding plate is arranged around the outer periphery of the fixed inner surrounding plate and is spaced apart from the fixed inner surrounding plate along the radial direction of the stirring impeller.

7. The impeller assembly according to claim 6, wherein the rotating surrounding plate is connected with the rotating shaft, and the rotation direction of the rotating surrounding plate is consistent with the rotation direction of the stirring impeller.

8. The impeller assembly according to claim 6, wherein the surrounding plate further comprises a fixed outer surrounding plate, and the fixed outer surrounding plate is arranged around the outer periphery of the rotating surrounding plate and is spaced apart from the rotating surrounding plate along the radial direction of the stirring impeller.

9. The impeller assembly according to claim 6, wherein a gap between the blades and the fixed inner surrounding plate, a gap between the fixed inner surrounding plate and the rotating surrounding plate, and a gap between the rotating surrounding plate and the fixed outer surrounding plate range from 1 mm to 3 mm.

10. The impeller assembly according to claim 6, wherein the dispersing teeth of the rotating surrounding plate are arranged parallel to the dispersing teeth of the fixed inner surrounding plate and the dispersing teeth of the fixed outer surrounding plate.

11. The impeller assembly according to claim 6, wherein the distribution density of the plurality of dispersing teeth on the surrounding plate is arranged to gradually increase from high to low along the height direction of the impeller assembly.

12. The impeller assembly according to claim 1, wherein the material of the blades and/or the surrounding plate includes aluminum alloy.

13. Mixing and stirring equipment for battery slurry, wherein the mixing and stirring equipment comprises:
a mixing tank, wherein a material mixing chamber and a discharge port for battery slurry are formed inside the mixing tank; and
the impeller assembly according to claim 1, wherein the stirring impeller of the impeller assembly is rotatably arranged in the material mixing chamber, and the surrounding plate of the impeller assembly is arranged at the discharge port.
